(19) United States
(12) Patent Application Publication
(10) Pub. No.: US 2016/0183575 A1
(43) Pub. Date: Jun. 30, 2016

(54) STABLE SWEETENER COMPOSITIONS

(71) Applicant: DSM IP ASSETS B.V., Heerlen (NL)

(72) Inventors: Igor GALAEV, Echt (NL); Henriëtte Maria Wilhelmina Jacoba Catharina UIJEN, Echt (NL); Peter Philip LANKHORST, Echt (NL)

(73) Assignee: DSM IP ASSETS B.V., Heerlen (NL)

(21) Appl. No.: 14/908,910

(22) PCT Filed: Jul. 31, 2014
(86) PCT No.: PCT/EP2014/066535

§ 371 Date: Jan. 29, 2016

Related U.S. Application Data
(63) Continuation-in-part of application No. 13/956,103, filed on Jul. 31, 2013, now abandoned.

(51) Int. Cl. A23L 1/236

(52) U.S. Cl. CPC A23L 1/2363; A23V 2002/00

(57) ABSTRACT

The present invention relates to a process for the preparation of a sweetener composition which method comprises:-providing a liquid composition comprising at least one steviol glycoside; and-heating the said liquid composition to at least about 90° C. for at least about 15 minutes, wherein the said heating is carried out in the presence of: a substance which inhibits nucleation and/or growth of steviol glycoside crystals; and/or in the presence of a substance which enables conversion of at least part of the steviol glycoside in the heating step into a substance which inhibits nucleation and/or growth of steviol glycoside crystals, thereby to prepare a sweetener composition. The invention also relates to a sweetener composition which is a liquid comprising at least one steviol glycoside and which is stable for at least about 6 days.

### FIELD OF THE INVENTION

The present invention relates to a method for the preparation of a sweetener composition. The invention also relates to a stable sweetener composition. The invention further relates to a method for the preparation of a beverage or foodstuff and to a beverage or foodstuff made with the stable sweetener composition.

### BACKGROUND TO THE INVENTION

Steviol glycosides are responsible for the sweet taste of the leaves of the stevia plant (Stevie rebaudiana Bertoni). These compounds range in sweetness from 40 to 300 times sweeter than sucrose. They are heat-stable, pH-stable, and do not ferment. They also do not induce a glycemic response when ingested, making them attractive as natural sweeteners to diabetics and others on carbohydrate-controlled diets.

Typically, steviol glycosides are made available as solid compositions since although the anhydrous form of Rebaudioside A is easily dissolved in water, in aqueous solutions, Rebaudioside A forms a hydrate, the solubility of which is rather low (about 8 g/L). Thus, when concentrated RebA solution is prepared, after a while a precipitate of RebA hydrate is formed in this solution. This prevents the use of concentrated syrups of Rebaudioside A either for the preparation of final products such as beverages or dairy products, or for household use.

### SUMMARY OF THE INVENTION

The present invention is based on the unexpected identification of a process for preparing a stable sweetener composition, which sweetener composition comprises at least one steviol glycoside, typically rebaudioside A (rebA). Accordingly, the invention concerns a process for the preparation of a sweetener composition in which precipitation of rebA hydrate is prevented, i.e. which is a stable liquid steviol glycoside solution.

Typically, when a concentrated rebA solution is prepared, after a while a precipitate of rebA hydrate is formed in this solution. The invention is based on the observation that heat treatment of a high purity rebA solution in the presence of an acid (for example phosphoric or citric) permits a stable solution to be prepared. Without wishing to be bound by theory, it seems that rebA is partially (5-10%) converted during heating with acid into rebaudioside B, which performs as a rebA-like impurity preventing further growth of initially formed crystals and hence precipitation.

Furthermore, it is shown herein that carboxymethylcellulose and Claristar® (a mannoproteins preparation) also prevent precipitation of rebA from concentrated solutions. Again, it seems that the presence in the heating step of a substance which interferes with growth of rebA crystals allows a stable liquid preparation to be achieved.

Accordingly, the invention relates to a process for the preparation of a sweetener composition which method comprises:
providing a liquid composition comprising at least one steviol glycoside; and
heating the said liquid composition,
wherein the said heating is optionally carried out: in the presence of a substance which inhibits nucleation and/or growth of steviol glycoside crystals; and/or in the presence of a substance which enables conversion of at least part of the steviol glycoside in the heating step into a substance which inhibits nucleation and/or growth of steviol glycoside crystals,
thereby to prepare a sweetener composition.

Accordingly, the invention also provides a sweetener composition which is a liquid comprising at least one steviol glycoside and which is stable for at least about 6 days, at least about 9 days, at least about 14 days, at least about 20 days at least one month, at least six months, at least eight months, at least 10 months, at least one year or longer.

Further provided by the invention is:

a method for the preparation of a beverage or a foodstuff which method comprises incorporating a sweetener composition of the invention during preparation of the said beverage or foodstuff;

a beverage or foodstuff comprising a sweetener composition of the invention or obtainable by a method of the invention for the preparation of a beverage or foodstuff;

use of a heating step in the preparation of a liquid sweetener composition comprising at least one steviol glycoside,

said heating step comprising heating a liquid composition comprising at least one steviol glycoside, optionally in the presence of: a substance which inhibits nucleation and/or growth of steviol glycoside crystals; and/or in the presence of a substance which enables conversion of at least part of the steviol glycoside in the heating step into a substance which inhibits nucleation and/or growth of steviol glycoside crystals.

### DETAILED DESCRIPTION OF THE INVENTION

Throughout the present specification and the accompanying claims, the words “comprise”, “include” and “having” and variations such as “comprises”, “comprising”, “includes” and “including” are to be interpreted inclusively. That is, these words are intended to convey the possible inclusion of other elements or integers not specifically recited, where the context allows.

The articles “a” and “an” are used herein to refer to one or to more than one (i.e. to one or at least one) of the grammatical object of the article. By way of example, “an element” may mean one element or more than one element.

The invention relates to sweetener compositions and to methods for making them. The sweetener compositions are characterized by being stable solutions (i.e. liquid compositions in which the one or more steviol remain substantially in solution) for extended periods of time, for example stable for at least about 6 days.

In the context of this invention, a sweetener composition is one where substantially all of the steviol glycoside(s) remain(s) in solution, i.e. remain dissolved. “Substantially all” of the steviol glycoside(s) implies that at least about 90%, at least about 95%, at least about 98%, at least about 99% of the steviol glycoside(s) remains in solution for the over an extended time period, for example at least about 6 days.

Stability will vary with temperature. Accordingly, stability according to the invention is determined at about room temperature, for example at a temperature of from about 20° C. to about 25° C.

According to the invention, there is provided a process for the preparation of a sweetener composition. The sweetener composition may be referred to as a soluble sweetener composition. A soluble sweetener composition in this context means that the composition is a liquid composition in which a sweetening compound (i.e. one or more steviol glycoside) is dissolved.

The method according to the invention comprises:
providing a liquid composition comprising at least one steviol glycoside; and
heating the said liquid composition, for example to at least about 90° C., such as to about 100° C., for example for at least about 15 minutes, thereby to prepare the sweetener composition.

Typically, the heating is carried out in the presence of a substance which inhibits nucleation and/or growth of steviol glycoside crystals; and/or in the presence of a substance which enables conversion of at least part of the steviol glycoside in the heating step into a substance which inhibits nucleation and/or growth of steviol glycoside crystals.

In this way, a stable sweetener composition may be achieved. The stable composition is a liquid composition. That is to say, it is a composition wherein the steviol glycosides substantially remain in solution.

The steviol glycoside in the liquid composition may be any steviol glycoside or mixture of steviol glycosides. Thus, the liquid composition may comprise one or more of rebA, rebB, rebC, rebD, rebF, rebM stevioside, dulcoside or steviolbioside

Typically the liquid composition will comprise at least rebA and typically the most abundant steviol glycoside in the composition will be rebA.

In the process of the invention, the liquid composition comprises at least about 15% (dry matter), at least about 20% (dry matter), at least about 25% (dry matter) or at least about 30% (dry matter) of steviol glycoside or more. The steviol glycoside content may be entirely composed of rebA.

In the process according to the invention, the pH of the liquid composition may be from about 3 to about 10.

The heating may be carried out in the presence of any suitable substance which inhibits nucleation and/or growth of steviol glycoside crystals; and/or in the presence of a substance which enables conversion of at least part of the steviol glycoside in the heating step into a substance which inhibits nucleation and/or growth of steviol glycoside crystals. That is to say, the heating is carried out in the presence of a substance which either itself interferes with the crystallization of the steviol glycoside or acts so as to convert a part of the steviol glycoside during the heating step into such a substance. For example, the substance may enable conversion of at least part of rebA to rebB during the heating step.

In the process of the invention, therefore, the liquid composition may comprise an acid. That is to say, the heating step of the process of the invention may be carried out in the presence of an acid. Any acid acceptable in the preparation of food products, such as citric acid, phosphoric, lactic acid, malic acid or acetic acid may be used.

In the process of the invention, the liquid composition may comprise a base. That is to say, the heating step of the process of the invention may be carried out in the presence of a base. Any base acceptable in the preparation of food products, such as NaOH may be used.

In the process of the invention, the liquid composition may a polyol, such as glycerol.

In the process of the invention, the liquid composition may comprise a polymeric substance. That is to say, the heating step of the process of the invention may be carried out in the presence of a polymeric substance. Suitable examples of polymeric substances are polysaccharides or polysaccharide derivatives, such as alginate and carboxymethylcellulose or proteins, such as mannoproteins.

Suitable amounts of any of the above-mentioned substances for use in a method of the invention may readily be determined by the skilled person.

Any of the aforementioned substances may be a substance which inhibits nucleation and/or growth of steviol glycoside crystals; and/or which enables conversion of at least part of the steviol glycoside in the heating step into a substance which inhibits nucleation and/or growth of steviol glycoside crystals. That is to say, any of the aforementioned substances may be one which interferes with the crystallization of the steviol glycoside or acts so as to convert a part of the steviol glycoside during the heating step into such a substance. For example, the substance may enable conversion of at least part of rebA to rebB during the heating step.

In the process of the invention, the liquid composition is heated. The liquid composition may be processed by high shear mixing prior to heating.

The heating may be carried out at from about 60° C. to about 100° C., such as at least about 60° C., at least about 70° C., at least about 80° C., at least about 90° C., at least about 95° C. or at about 100° C.

In the process of the invention, the liquid composition may be heated for at least about 1 minute, at least about 5 minutes, at least about 10 minutes or more. The heating may be carried out for at least about 30 minutes, at least about 60 minutes or at least about 210 minutes.

Thus, in the process of the invention, the liquid composition may be heated for at least about 1 minute to at least about 210 minutes, for example from about 30 minutes to about 200 minutes.

Thus, in the process of the invention, the liquid composition may be heated for:

at least about 1 minute to at least about 210 minutes at about 60° C. to about 100° C., such as at least about 60° C., at least about 70° C., at least about 80° C., at least about 90° C., at least about 95° C. or at about 100° C.,

for example from about 30 minutes to about 200 minutes at about 60° C. to about 100° C., such as at least about 60° C., at least about 70° C., at least about 80° C., at least about 90° C., at least about 95° C. or at about 100° C.

The process of the invention allows a stable (as defined above) sweetener composition to be prepared. The sweetener composition is stable for at least about 6 days, at least about 9 days, at least about 14 days, at least about 20 days, at least one month, at least about six months, at least about eight months, at least about 10 months, at least about one year or longer.

The invention thus provides a sweetener composition comprising at least one steviol glycoside which is a liquid and which is stable for at least about 6 days, at least about 9 days, at least about 14 days, at least about 20 days, at least one month, at least about six months, at least about eight months, at least about 10 months, at least about one year or longer.

The heating in the process and use of the invention may be defined in terms of any combination of temperature and time as mentioned herein.

The sweetener composition of the invention may be one obtainable by a process according to the invention.

The invention further provides a method for the preparation of a beverage or a foodstuff which method comprises incorporating a sweetener composition according to the invention, for example a sweetener composition obtainable by a process according to the invention during preparation of the said beverage or foodstuff.

Thus, the invention also provides a beverage or foodstuff comprising a sweetener composition of the invention, for example a sweetener composition obtainable by a process according to the invention.

The invention also provides the use of a heating step as defined herein in the preparation of a sweetener composition comprising at least one steviol glycoside, said heating step comprising heating a liquid composition comprising at least one steviol glycoside, for example to at least about 90° C. for at least about 15 minutes.

The sweetener composition according to the present invention may be used in any application known for such sweetener compositions. In particular, they may for instance be used as a sweetener, for example in a foodstuff or a beverage. For example the sweetener composition may be formulated in soft drinks, as a chewing gum, dairy product such as yoghurt (eg. plain yoghurt), cake, cereal or cereal-based food, nutraceutical, pharmaceutical, edible gel, confectionery product, cosmetic, toothpastes or other oral cavity composition, etc.

In addition, the sweetener composition can be used as a sweetener not only for drinks, foodstuffs, and other products dedicated for human consumption, but also in animal feeds with improved characteristics.

Accordingly, the invention provides, inter alia, a foodstuff, feed or beverage which comprises a sweetener composition of the invention or a sweetener composition prepared according to a process of the invention.

During the manufacturing of foodstuffs, drinks, pharmaceuticals, cosmetics, table top products, chewing gum the conventional methods such as mixing, kneading, dissolution, pickling, permeation, percolation, sprinkling, atomizing, infusing and other methods can be used.

The sweetener composition obtained in this invention is used in liquid forms. It can be added before or after heat treatment of food products. The amount of the sweetener depends on the purpose of usage. It can be added alone or in the combination with other compounds.

The sweetener composition produced according to the method of the invention may be blended with one or more further non-calorific or calorific sweeteners. Such blending may be used to improve flavour or temporal profile or stability. A wide range of both non-calorific and calorific sweeteners may be suitable for blending with the sweetener composition. For example, non-calorific sweeteners such as mogroside, monatin, aspartame, acesulfame salts, cyclamate, sucralose, saccharin salts or erythritol. Calorific sweeteners suitable for blending with the sweetener composition include sugar alcohols and carbohydrates such as sucrose, glucose, fructose and HFCS. Sweet tasting amino acids such as glycine, alanine or serine may also be used.

The sweetener composition can be used in the combination with a sweetener suppressor, such as a natural sweetener suppressor. It may be combined with an umami taste enhancer, such as an amino acid or a salt thereof.

The sweetener composition can be combined with a polyol or sugar alcohol, a carbohydrate, a physiologically active substance or functional ingredient (for example a carotenoid, dietary fiber, fatty acid, saponin, antioxidant, nutraceutical, flavonoid, isothiocyanate, phenol, plant sterol or stanol (phytosterols and phytostanols), a polyols, a prebiotic, a probiotic, a phytoestrogen, soy protein, sulfides/thiols, amino acids, a protein, a vitamin, a mineral, and/or a substance classified based on a health benefits, such as cardiovascular, cholesterol-reducing or anti-inflammatory.

A sweetener composition according to the invention may include a flavoring agent, an aroma component, a nucleotide, an organic acid, an organic acid salt, an inorganic acid, a bitter compound, a protein or protein hydrolyzate, a surfactant, a flavonoid, an astringent compound, a vitamin, a dietary fiber, an antioxidant, a fatty acid and/or a salt.

A sweetener composition of the invention may be applied as a high intensity sweetener to produce zero calorie, reduced calorie or diabetic beverages and food products with improved taste characteristics. Also it can be used in drinks, foodstuffs, pharmaceuticals, and other products in which sugar cannot be used.

The examples of products where the sweetener composition of the invention can be used as a sweetening compound can be as alcoholic beverages such as vodka, wine, beer, liquor, sake, etc; natural juices, refreshing drinks, carbonated soft drinks, diet drinks, zero calorie drinks, reduced calorie drinks and foods, yogurt drinks, instant juices, instant coffee, powdered types of instant beverages, canned products, syrups, fermented soybean paste, soy sauce, vinegar, dressings, mayonnaise, ketchups, curry, soup, instant bouillon, powdered soy sauce, powdered vinegar, types of biscuits, rice biscuit, crackers, bread, chocolates, caramel, candy, chewing gum, jelly, pudding, preserved fruits and vegetables, fresh cream, jam, marmalade, flower paste, powdered milk, ice cream, sorbet, vegetables and fruits packed in bottles, canned and boiled beans, meat and foods boiled in sweetened sauce, agricultural vegetable food products, seafood, ham, sausage, fish ham, fish sausage, fish paste, deep fried fish products, dried seafood products, frozen food products, preserved seaweed, preserved meat, tobacco, medicinal products, and many others. In principal it can have unlimited applications.

The sweetened composition comprises a beverage, non-limiting examples of which include non-carbonated and carbonated beverages such as colas, ginger ales, root beers, ciders, fruit-flavored soft drinks (e.g., citrus-flavored soft drinks such as lemon-lime or orange), powdered soft drinks, and the like; fruit juices originating in fruits or vegetables, fruit juices including squeezed juices or the like, fruit juices containing fruit particles, fruit beverages, fruit juice beverages, beverages containing fruit juices, beverages with fruit flavorings, vegetable juices, juices containing vegetables, and mixed juices containing fruits and vegetables; sport drinks, energy drinks, near water and the like drinks (e.g., water with natural or synthetic flavorants); tea type or favorite type beverages such as coffee, cocoa, black tea, green tea, oolong tea and the like; beverages containing milk components such as milk beverages, coffee containing milk components, cafe au lait, milk tea, fruit milk beverages, drinkable yogurt, lactic acid bacteria beverages or the like; and dairy products.

Generally, the amount of sweetener present in a sweetened composition varies widely depending on the particular type of sweetened composition and its desired sweetness. Those of ordinary skill in the art can readily discern the appropriate amount of sweetener to put in the sweetened composition.

The amount of the sweetener composition of the invention use depends on the purpose of usage and on the concentration of steviol glycoside(s) in the sweetener composition. It can be added alone or in the combination with other compounds.

Compositions of the present invention which are made using the sweetener composition of the invention can be made by any method known to those skilled in the art that provides homogenous even or homogeneous mixtures of the ingredients. These methods include dry blending, spray drying, agglomeration, wet granulation, compaction, co-crystallization and the like.

A sweetener composition of the invention may be kept in an appropriate packing using appropriate packing material in any shape or form which is convenient to carry or dispense or store or transport the sweetener composition.

A sweetener composition of the invention may include functional ingredients, colorants or flavors.

A reference herein to a patent document or other matter which is given as prior art is not to be taken as an admission that that document or matter was known or that the information it contains was part of the common general knowledge as at the priority date of any of the claims.

The disclosure of each reference set forth herein is incorporated herein by reference in its entirety.

The present invention is further illustrated by the following Examples:

### EXAMPLES

### Example 1

### Stabilization of Solutions of Rebaudioside A

20 to 30% solutions of 98% pure RebA were heated for 2 h at 90° C. in the presence of phosphoric or citric acid as indicated in Table 1. The thus treated solutions remained clear after at least 14 days. A voluminous crystalline precipitate is formed in rebA solutions of these concentrations after 24 h when these solutions were not subjected heating in the presence of acid.

TABLE 1
Stability of RebA solutions against crystallization

| RebA | | | After | After |
|---|---|---|---|---|
| concentration | | On preparation | 9 days | 14 days |
| 20% | 0.5% H₃PO₄ | clear | clear | clear |
| 25% | 0.5% H₃PO₄ | clear | clear | clear |
| 30% | 0.5% H₃PO₄ | clear | clear | clear |
| 20% | 0.5% citric | clear | clear | clear |
| | acid | | | |
| 25% | 0.5% citric | clear | clear | clear |
| | acid | | | |
| 30% | 0.5% citric | clear | clear | clear |
| | acid | | | |
| 20% | Citr-phosph | clear | clear | clear |
| | pH 3 | | | |
| 30% | Citr-phosph | clear | clear | clear |
| | pH 3 | | | |
| 20% | Citr-phosph | clear | clear | clear |
| | pH 4 | | | |

Heating of RebA solutions without addition of acids for different periods of time at 100° C. resulted in some stabilization against crystallization of RebA (see Table 2)

TABLE 2
Stability of RebA solutions against crystallization

| Reb A | heated | June 13 | June 19 |
|---|---|---|---|
| concentration | at 100° C. | after 6 days | after 12 days |
| 15% | 15 min | clear | clear |
| | 30 min | crystals | |
| | 60 min | clear | clear |
| | 120 min | turbid | crystals |
| 20% | 15 min | clear | clear |
| | 30 min | crystals | |
| | 60 min | crystals | |
| | 120 min | clear | clear |
| 25% | 15 min | clear | clear |
| | 30 min | crystals | |
| | 60 min | clear | clear |
| | 120 min | clear | clear |
| 30% | 15 min | crystals | |
| | 30 min | crystals | |
| | 60 min | crystals | |
| | 120 min | clear | clear |

The relative amount of rebA and rebB in the heat treated solutions was determined by HPLC. The results are set out in Table 3: S1 is rebA dissolved in water; S2 is rebA dissolved in 0.5% phosphoric acid; S3 is rebA dissolved in 0.5% citric acid. Conversion of rebA into rebB was observed at acidic conditions after 2 hours heat treatment at 90° C.

TABLE 3
HPLC analyses shows conversion of rebA into rebB
at acidic conditions after 2 hours heat treatment
at 90° C.

| 20% Stevia | Reb A % | Reb B % |
|---|---|---|
| S1 (MQ 90° C. pH 6) | 97 | 1.6 |
| S2 (H3PO4 90° C. pH 2.5) | 76 | 13.5 |
| S3 (Citric 90° C. pH 2.5) | 88 | 67 |

### Example 2

### Stabilization of Solutions of Rebaudioside A

A stock solution of 5% Carboxymethylcellulose, CMC (Blanose 7LF, a low viscosity grade of CMC) was prepared. A 20% solution of mannoproteins (Claristar®, batch MANZL0827A) was used.

200 mg of Rebaudioside A were weighed in each vial. To the Rebaudioside crystals water and CMC stock solution or Claristar® solution was pipetted to obtain the concentrations given in Table 1. These solutions were stored at 90° C. in a stove for 1 hour to ensure that all crystals are dissolved, and a homogeneous solution was obtained by thorough shaking (vortex) before and after the treatment with 90° C.

The vials were stored at room temperature, and the appearance of crystals was monitored daily by visual inspections. The results are given in Table 4.

TABLE 4
Composition of samples (% w/w dry matter) and delay
of crystallization (days)

| | | | | First appearance of |
|---|---|---|---|---|
| Sample nr | Reb A (%) | CMC (%) | Claristar ® (%) | crystals (days) |
| 13 | 20 | 0.5 | 0 | >12 d |
| 14 | 20 | 1 | 0 | >12 d |
| 15 | 20 | 0 | 2 | 10 d* |
| 16 | 20 | 0 | 4 | >12 d |

*small crystal on day 10, completely crystallized on day 11.

It should be noted, that if the solutions are prepared without heating to 90° C., but, instead, with gentle heating with tap water, the Rebaudioside A crystallizes within 1 day. Apparently, seeding crystals are present even if the remain invisible to the naked eye.

The degradation of Rebaudioside A into Rebaudioside B after the 90° C. treatment was estimated by means of LC/MS. This degradation is expressed as a ratio of Reb A: Reb B, which was 72 in sample 14, 80 in sample 16 and 91 in starting material. Apparently, there is not much degradation and the stabilization of the Rebaudioside A solution must be attributed to the additives CMC and Claristar®. CMC was more efficient in this experiment, even at the 4 times lower concentrations tested. In conclusion, solutions of 20% of rebaudioside A can be stabilized for at least 12 days by the addition of CMC 0.5% or 1% or by the addition of Claristar® 4% on dry matter basis.

### Example 3

### Lona Term Stabilization of Solutions of Rebaudioside A

10 to 20% solutions of 98% pure RebA were heated for 2 h at 90° C. in the presence of phosphoric acid, citric acid, malic acid, lactic acid or alginate as indicated in Table 5. The solutions were cooled to room temperature and stored.

The stability of the treated solutions was determined at around 10 and around 12 months after preparation and at around 8 months in the case of the alginate and glycerol containing solutions. The results are set out in Tables 5 and 6.

TABLE 5
Stability evaluation of 10-25% Stevia in citric, lactic and malic acid solutions
10 and 12 months after preparation

| | | | | Stability |
|---|---|---|---|---|
| Sample ID | Rebaudioside A | Prep dd | Stability 01.05.2014 | 07.07.2014 |
| 0.5% citric acid | 10% | 23.05.2013 | Stable clear solution | Stable clear |
| | | | | solution |
| | 20% | 04.06.2013 | Stable clear solution | Stable clear |
| | | | | solution |
| | 25% | 04.06.2013 | Stable clear solution | Stable clear |
| | | | | solution |
| 1% citric acid | 15% | 23.05.2013 | Stable clear solution | Stable clear |
| | | | | solution |
| 0.5% malic acid | 20% | 05.07.2013 | Stable clear solution | Stable clear |
| | | | | solution |
| 0.5% lactic acid | 20% | 05.07.2013 | Stable clear solution | Stable clear |
| | | | | solution |
| 0.5% alginate | 20% | 03.06.2013 | Stable clear solution | crystallized |
| 5% glycerol + 1% | 20% | 23.05.2013 | Some flocks in a clear | crystallized |
| phosph. acid | | | solution | |

TABLE 6
Stability evaluation of rebaudioside A in alginate and
glycerol solutions 8 months after preparation

| Rebaudioside A solutions | | | Stability |
|---|---|---|---|
| | Rebaudioside A | | after |
| Solution | concentration | Prepared | 8 months |
| 0.5% aliginate | 25% | 04.06.2013 | Clear |
| | | | solution |
| 1% phosphoric acid + 5% | 20% | 23.05.2013 | Clear |
| glycerol | | | solution |

Rebaudioside A solutions containing 10-25% dissolved in either 0.5-1% acid citric, malic and lactic as prepared according the described procedure showed clear solutions after one year storage at room temperature. Rebaudioside A solutions in combination with alginate and glycerol were stable for 8 months.

1. A process for the preparation of a sweetener composition which method comprises:
providing a liquid composition comprising at least one steviol glycoside; and
heating the said liquid composition,
wherein the said heating is carried out in the presence of: a substance which inhibits nucleation and/or growth of steviol glycoside crystals; and/or in the presence of a substance which enables conversion of at least part of the steviol glycoside in the heating step into a substance which inhibits nucleation and/or growth of steviol glycoside crystals,
thereby to prepare a sweetener composition.

2. A process according to claim 1, wherein the said liquid composition is heated to at least 60° C., at least 70° C., at least 80° C., at least 90° C., at least 95° C. or at 100° C.

3. A process according to claim 1, wherein the said liquid composition is heated for at least 1 minute, at least 5 minutes, at least 10 minutes or more.

4. A process according to claim 1, wherein the at least one steviol glycoside is at least rebA, rebB, rebC, rebD, rebF, stevioside, dulcoside or steviolbioside.

5. A process according to claim 1, wherein the liquid composition comprises at least about 15% (dry matter), at least about 20% (dry matter), at least about 25% (dry matter) or at least about 30% (dry matter).

6. A process according to claim 1, wherein the pH of the liquid composition is from about 3 to about 10.

7. A process according to claim 1, wherein the heating is carried out in the presence of an acid, optionally comprising citric acid, phosphoric acid, malic acid or lactic acid.

8. A process according to claim 1, wherein the heating is carried out in the presence of a base, optionally comprising NaOH.

9. A process according to claim 1, wherein the heating is carried out in the presence of a polymeric substance, optionally comprising alginate, carboxymethylcellulose or mannoproteins.

10. A process according to claim 1, wherein the liquid composition is processed by high shear mixing prior to heating.

11. A process according to claim 1, wherein the heating is carried out at about 95° C. to about 100° C.

12. A process according to claim 1, wherein the heating is carried out for at least about 30 minutes, at least about 60 minutes or at least about 210 minutes.

13. A process according to claim 1, wherein the sweetener composition is stable for at least about 6 days, at least about 9 days, at least about 14 days, at least about 20 days at least one month, at least six months, at least eight months, at least 10 months, at least one year or longer.

14. A process according to claim 1, wherein the stability is determined at a temperature of from about 20° C. to about 25° C.

15. A sweetener composition which is a liquid comprising at least one steviol glycoside, optionally comprising rebaudioside A, and which is stable for at least about 6 days, at least about 9 days, at least about 14 days, at least about 20 days, at least one month, at least six months, at least eight months, at least 10 months, at least one year or longer.

16. A sweetener composition according to claim 15 obtainable by a process comprising providing a liquid composition comprising at least one steviol glycoside; and
heating the said liquid composition,
wherein the said heating is carried out in the presence of: a substance which inhibits nucleation and/or growth of steviol glycoside crystals; and/or in the presence of a substance which enables conversion of at least part of the steviol glycoside in the heating step into a substance which inhibits nucleation and/or growth of steviol glycoside crystals,
thereby to prepare a sweetener composition.

17. A method for preparation of a beverage or a foodstuff which method comprises incorporating a sweetener composition according to claim 15 during preparation of the said beverage or foodstuff.

18. A beverage or foodstuff comprising a sweetener composition according to claim 15.

19. A heating step used in preparation of a liquid sweetener composition comprising at least one steviol glycoside,
said heating step comprising heating a liquid composition comprising at least one steviol glycoside in the presence of: a substance which inhibits nucleation and/or growth of steviol glycoside crystals; and/or in the presence of a substance which enables conversion of at least part of the steviol glycoside in the heating step into a substance which inhibits nucleation and/or growth of steviol glycoside crystals.
